(19) United States
(12) Patent Application Publication
(10) Pub. No.: US 2014/0198760 A1
(43) Pub. Date: Jul. 17, 2014

(54) METHOD FOR TRANSFERRING INFORMATIONAL DATA

(71) Applicant: Wilhelm Meyrath, Klosterneuburg (AT)

(72) Inventor: Wilhelm Meyrath, Klosterneuburg (AT)

(21) Appl. No.: 14/234,651

(22) PCT Filed: Jul. 2, 2012
(86) PCT No.: PCT/EP2012/062808

§ 371 Date: Jan. 24, 2014

(30) Foreign Application Priority Data
Jul. 28, 2011 (DE) 102011079972.9

(51) Int. Cl. H04W 72/08; H04W 76/02

(52) U.S. Cl. CPC H04W 72/082; H04W 76/02
USPC 370/329

(57) ABSTRACT

A method for transferring informational data in a passenger transportation device is provided. The passenger transportation device, comprises an informational system having output units, on which information, is output to the passengers. In the passenger transportation device, by means of a masking signal, the establishment of a connection between mobile terminals located in the passenger transportation device and radio communication systems outside of the passenger transportation device is suppressed and/or diverted to a radio communication system located in the passenger transportation device. Additionally, the masking signal is encoded and modulated by a control unit so that informational data (ID) are transferred from the informational system to the output units with the aid of the masking signal and then output. The masking signal is used for wireless transmission of informational data, in addition to a function of the signal as an interference signal to suppress communication with external radio communications systems.

### CROSS-REFERENCE TO RELATED APPLICATIONS

This application claims priority to PCT Application No. PCT/EP2012/062808, having a filing date of Jul. 2, 2012, the entire contents of which are hereby incorporated by reference.

### FIELD OF TECHNOLOGY

The following relates to methods for transferring informational data, especially audio and/or video data in the form of so-called streams, in a passenger transportation device.

### BACKGROUND

A mobile terminal (e.g. mobile telephone, smartphone, etc.), which is logged into a radio communication system continuously exchanges specific information with the radio communication system by means of radio waves. If other electronic devices are located in the transmit area of the mobile terminal, such as in an aircraft for example, the radio waves can cause disturbances in these devices. Therefore, the use of mobile terminals, such as e.g. mobile telephones is forbidden in aircraft.

On the other hand, use of mobile communication devices such as mobile telephones, laptops etc. is very widespread nowadays and there is a demand for using private communication devices or mobile terminals such as mobile telephones for example as easily as possible and without restriction—e.g. during journeys.

Methods are known from different publications, such as e.g. EP 1 961 255 or EP 1 969 875 B1, through which use of mobile terminals, e.g. on board an aircraft is suppressed and/or diverted to a radio communication system within the passenger transport means and can thus be used without risk to safety. In order to prevent communication between a mobile terminal and a radio communication system outside the passenger transportation means, or to divert it to a radio communication system within the passenger transportation means, as described for example in the publication EP 1 969 875 B1—interference signals or masking signals, which are generated by separate control units (e.g. interference signal generator etc) are frequently used. This means that a radio communication system outside the passenger transportation device is no longer found by mobile terminals for establishing a connection and if necessary the connection is established with a radio communication system within the passenger transportation device.

Moreover, there is increasingly a necessity in passenger transportation devices such as e.g. aircraft, ships, railway trains etc. to transfer data for informational purposes and/or for entertainment for example. Since currently, for safety reasons, mobile devices may usually only be used to a restricted extent or not at all, the passengers are supplied with information and/or entertainment programs via informational and/or on-board entertainment systems for example.

The passengers in passenger transportation devices such as aircraft, railway trains, ships etc. for example, are provided with information such as current journey/flight data, travel information, entertainment in the form of audio and/or video data etc. via such informational systems, at the output units belonging to the informational system. Such output units can for example be display screens with associated operating devices, which are fitted for example to the passenger seat, or display screens, which are permanently fixed to a ceiling and/or a wall of the respective passenger transportation device, and are centrally controlled. The data or the information can also be output however to an electronic information service, e.g. to a so-called service wagon or service cart.

In aircraft, for example, what are known as in-flight entertainment systems are used to transmit data and/or information to the passengers. These systems in particular have been subject to much development over the last 25 years. Initially, these systems consisted only of audio systems via which the passengers were provided with audio information and/or data (e.g. music etc.). From the 1980s onwards the systems were expanded by broadcasting video information—usually VHS video tapes, which could be viewed via group display screens, and since the early 1990s there have been the first in-the-seat video systems in which a video can be selected by a passenger for example, which could then be selected and output to a display screen belonging to a seat with an associated operating device. In the meantime this information and entertainment system has been expanded by for example interactive games, audio and video-on-demand etc. and also e.g. real-time flight information on maps (e.g. moving-map systems etc.) being provided to a passenger for entertainment and information purposes on a flight. But in trains and/or ships too there have recently been approaches and ideas for providing on-board entertainment and/or informational systems.

The on-board entertainment systems in aircraft usually consist of a central distribution unit, in which the audio and/or video data is stored centrally and from which the data is then transmitted to a plurality of output units (e.g. display screens—for example in the aircraft cabin or for each passenger seat). Usually such an on-board entertainment system demands expensive and complex cabling, so that—especially with in-seat entertainment systems (i.e. each passenger seat has an output unit able to be controlled via a corresponding operating device, wherein applications such as e.g. video-on-demand, audio-on-demand etc. can be used)—transmission of the data (e.g. video streams, audio streams, etc.) is made possible with corresponding quality and speed.

However, this cabling has the disadvantage that for corresponding cabling of each passenger seat it is relatively expensive and complex. In addition, such cabling can constitute a considerable weight e.g., in a large aircraft, meaning that the weight of the aircraft, and thus the flight costs can increase considerably.

Therefore, separate proprietary or also standardized radio systems such as systems based on Wi-Fi or Wireless LAN can be used as an alternative for the transmission of the data. However these systems are currently being tested primarily for Internet use on-board and they also have the disadvantage that, in addition to already existing systems (e.g. central distribution unit of the on-board entertainment system, on-board radio communication system, etc.), a further communication system with hardware and software has to be installed in order to provide this transmission path for the data. Also—especially in an aircraft—additional radio systems require new radio approvals and/or permissions, since emission data (e.g. output power, frequency bands, antenna installations, etc.) might possibly change.

### SUMMARY

An aspect relates to a method for transfer of informational data in a passenger transport device through which, in a simple manner, using existing resources and systems, informational data can be made available by an informational system.

A further aspect relates to a method of the type specified at the start, wherein a masking signal is encoded and modulated by a control unit which is accommodated within a passenger transportation device, especially an aircraft, railway train, ship etc., such that informational data—, especially data streams for information and/or entertainment (e.g. video streams, audio streams, etc.)—is transferred with the aid of the masking signal from the informational system to the output units belonging to the informational system and is then output or displayed at the output units.

Another aspect relates to resources and/or systems already available in a passenger transportation device (e.g. radio communication system, masking signal) being used by the inventive method. Expensive and complex setting up of additional transmission paths such as e.g. additional cabling, additional transmission system, etc. can be dispensed with in this way. In a simple manner, systems already available such as e.g. the radio communication system within the passenger transportation device and/or available resources such as e.g. a spectrum of the masking signal can be useful for transmission of the informational data—especially for large amounts of data (e.g. audio and/or video data in the form of so-called streams or data streams).

The masking signal or the spectrum of the masking signal is thus used in addition to its function as interference signal for suppressing a connection setup and/or communication with radio communication systems outside the passenger transportation device, as a transmission medium. The spectrum of the masking signal, which is ideally embodied as a broadband signal with a noise-like character instead of as a stochastic interference signal, is thus made available in a simple manner for transmission of the informational data. Furthermore, this enables a broadband transmission medium to be obtained for the informational data with little hardware outlay. On the other hand, the radio technology changes are for example relatively small, since essentially only the data content transmitted by means of the masking signal, but not the emission data (output power, frequency bands, antenna installation, etc.) have to be changed.

In an embodiment of the inventive method, the informational data is transmitted from the informational system via an interface to the control unit. The masking signal is then generated by the control unit, which is then used for the transport of the informational data to the output units. The informational data is transmitted via the interface in a simple manner from the informational system to the control unit, by which the masking signal is already generated and can then be included by the control unit through corresponding encoding and modulation of the masking signal for transport as a useful signal via the masking signal to the output units.

The output units of the informational system can be equipped with corresponding receive units for receiving and displaying the informational data. By equipping the output units of the informational system with corresponding receive units, the masking signal with the informational data can be received in a simple manner. The informational data can then, for example, be decoded accordingly by the output unit or converted and output.

It is advantageous for a broadband signal with a noise-like character to be used as the masking signal. Usually, in aircraft for example, a stochastic signal is used as an interference or masking signal in order to suppress a connection setup between mobile terminals located in the aircraft and radio communication systems outside the aircraft or divert it to a radio communication system located in the aircraft. Such an interference signal is, for example, generated by a noise generator. If however a broadband signal with a noise-like character is selected for the masking signal, then in a simple manner, e.g. by suitable encoding and modulation, the entire band can be occupied. That is, a masking signal is generated, by which on the one hand a high data rate is made available for the transmission of the informational data and for which on the other hand the masking or noise effect is also maintained for a connection established to radio communication systems outside the passenger transportation device.

A correspondingly favorable or suitable modulation method for the masking signal is represented in this case especially by the so-called spread-spectrum modulation or the so-called frequency spreading. In this method, from communication technology, a narrowband signal—for example the information signal to be transmitted—is converted into a signal with a greater bandwidth than is necessary for information transmission and the transmitted energy. Thus, the information to be transmitted is distributed to a larger frequency range. In the so-called despreading process interference in the band—i.e. signals from radio communication systems outside the passenger transportation device—are thus suppressed. A spread-spectrum modulation has the particular advantage of greater robustness in relation above all to narrowband interference. Thus, such encoding/modulation of the masking signal above all enables both the function as interference signal and also the function of data transmission to be fulfilled.

As an alternative, the so-called Orthogonal Frequency Division Multiplexing (OFDM) or the orthogonal frequency multiplex method can also be used as a modulation method for the masking signal, in which a number of orthogonal carrier signals are used for digital data transmission. The informational data to be transmitted at a high data rate (e.g. video data, audio data, etc.) is divided up in such cases between a number of subdata streams with a low data rate and then each subdata stream is modulated with a conventional modulation method (e.g. quadrature amplitude modulation, etc.) with a low bandwidth. Subsequently, the individual carrier signals are added. The use of orthogonal carrier signals enables the carrier signals to be distinguished again at the receiver for demodulation. The advantage of OFDM lies in the fact that the data transmission can be adapted very easily to the peculiarities of a transmission channel.

So-called channel coding is used e.g. as suitable coding of the masking signal. Channel coding refers to a method in communication technology in which digital data is protected from transmission errors during transmission over faulty channels by addition of redundant information. The redundant information transmitted in addition to the information then makes it possible to correct transmission errors very easily.

It is advantageous for fixed and/or mobile output devices to be used as output units of the informational system. The wireless transmission of the informational data via the masking signal ideally enables fixed and also mobile output units to be accessed in the passenger transportation device. In particular, mobile output units such as information screens on service wagons etc. provide the opportunity of offering information, entertainment, etc. as flexibly as possible within the passenger transportation device.

In a specific embodiment, variant of the inventive method a part of a spectrum of the masking signal for transmission of informational data of the informational system to mobile terminals located in the passenger transportation device, especially for terminals based on the Universal Mobile Telecommunication System or UMTS standard, is used. Since for example the so-called spread-spectrum or frequency spreading technology is used in UMTS for example, with suitable modulation of the masking signal—e.g. spread-spectrum modulation—a part of the spectrum of the masking signal can be used very simply for direct transmission of the informational data to a corresponding mobile terminal. On the transmitter side the radio communication system existing within the passenger transportation device can then be used very easily, wherein the informational data to be transmitted from the informational system can be conveyed for example to the radio communication system.

### BRIEF DESCRIPTION

The embodiments of the invention are explained below by way of examples, which refer to the enclosed figures, wherein:

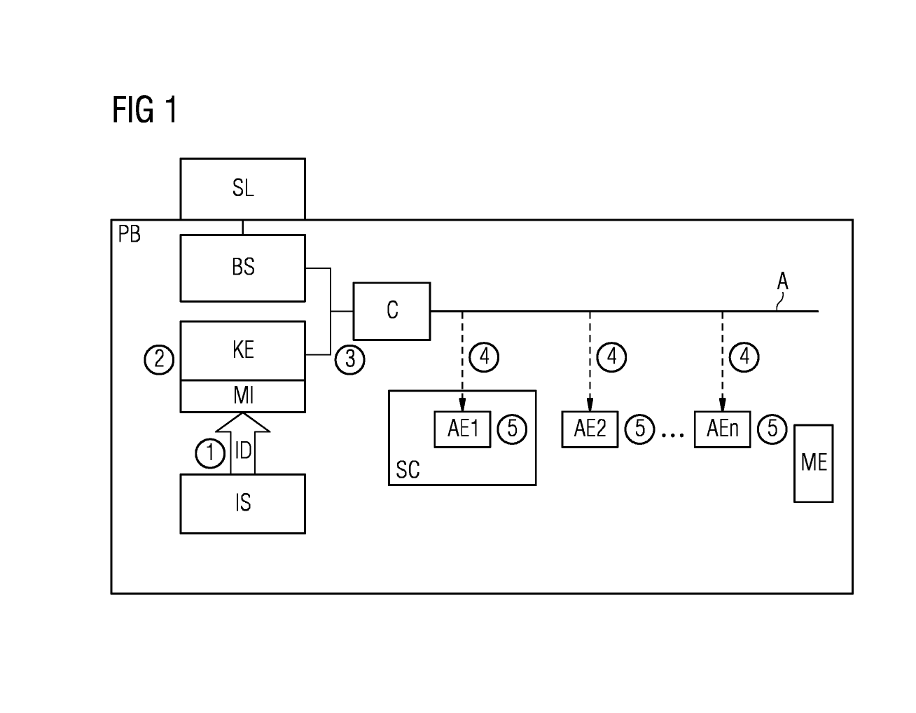

FIG. 1 shows a schematic diagram of a typical sequence of the inventive method for transmission of informational data in a passenger transportation device, and

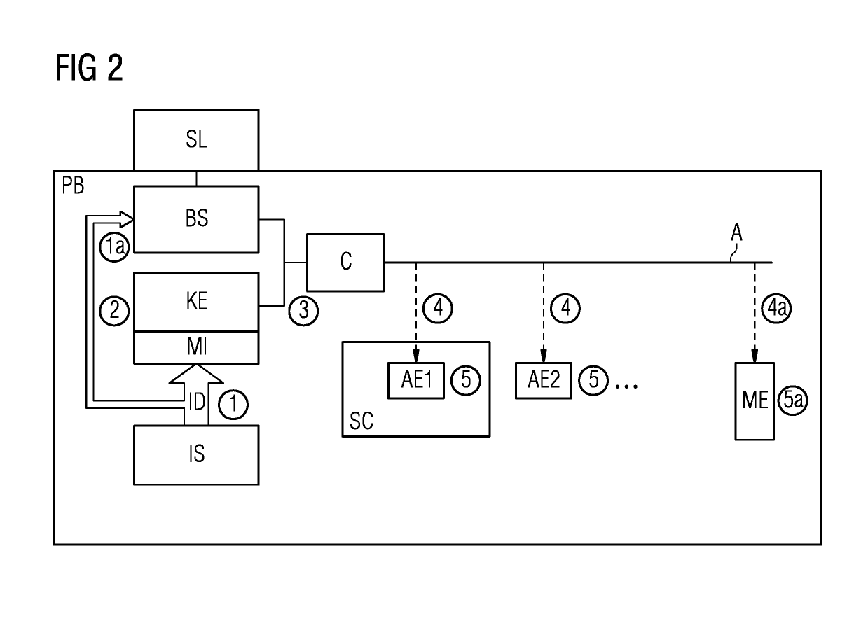

FIG. 2 a schematic and typical sequence of the inventive method, wherein a part of the spectrum of the masking signal is used for informational data transmission to mobile terminals.

### DETAILED DESCRIPTION

FIG. 1 shows a schematic diagram of a typical transportation device PB such as an aircraft, a railway train, a ship, etc. This passenger transportation device PB typically comprises an informational system IS, to which output units AE1, . . . , AEn belong. With the informational system IS passengers of the passenger transportation device PB can be provided with informational data ID such as e.g. information and/or entertainment programs.

To this end the informational data ID, which is especially present as audio and/or video data and is transmitted in the form of data streams—referred to as streams—is transported from the informational system IS to the output units AE1, . . . , AEn. The output units AE1, . . . , AEn can be fixed units or be fitted to a mobile unit SC (e.g. service wagon). In FIG. 1 the output unit AE1 is fitted as a display to a service wagon SC and can thus be moved through the passenger transportation device PB. The output units AE2, . . . , AEn are embodied for example as fixed screens, which are installed for example on a wall and/or ceiling of the passenger transportation device PB and are centrally controlled or they are for example fitted as display screens with operating controls directly at the respective passenger seats and informational data ID can be selected by the respective passenger individually by means of the operating controls.

Furthermore the passenger transportation device PB includes a radio communication system BS, C, A, comprising a base station BS, a combination unit C and an antenna unit A. The base station BS has a connection SL for connecting the radio communication system BS, C, A within the passenger transportation device to a satellite. Via this connection SL a communication link can then be established by a satellite to a radio communication system outside the passenger transportation device PB.

In addition a control unit KE is provided in the passenger transportation device PB, from which a masking signal or interference signal is generated. The masking signal is combined via the combination unit C with the signals of the base station BS and propagated in the passenger transportation device via the antenna unit A. A noise generator or interference signal generator can be used for example as the control unit KE. The masking signal prevents mobile terminals ME such as mobile telephones etc. for example located within the passenger transportation device PB from setting up a connection to a radio communication system outside the passenger transportation device PB.

Since this type of connection setup interferes through the signals necessary for it (e.g. from mobile terminals and/or the external radio communication systems) with the electronic devices of the passenger transportation device PB for example and thus—in aircraft in particular—can lead to safety risks, the connection setup is suppressed by the masking signal and/or diverted to the radio communication system BS, C, A or to the base station BS respectively within the passenger transportation device PB. Through the masking signal the external radio communication systems outside the passenger transportation device PB are no longer found by the mobile terminals ME within the passenger transportation device PB and if necessary the mobile terminals ME are logged into the radio communication system BS, C, A within the passenger transportation device PB.

The antenna unit A can for example be embodied as a so-called leaky line, in which a variant of a coaxial cable—a so-called slot cable—is used as an elongated antenna. This has the advantage that controlled high-frequency power can be emitted and accepted over the entire length of the cable or of the antenna unit and the signals can be bought as close as possible to the terminals. Therefore a power of the emitted signals—such as e.g. the masking signal and also the signals of the base station BS—can be kept low, so that for example electronic devices of the passenger transportation device PB are not disturbed.

Furthermore the control unit KE has an interface MI, known as a Media Interface. Via the interface MI, in a first method step 1, informational data ID is forwarded from the informational system IS to the control unit KE. In a second method step 2 a masking signal is then generated by the control unit KE and encoded and modulated accordingly, so that the informational data ID can then be forwarded in a third method step 3 via the combination unit C and the antenna unit A of the radio communication system BS, C, A located in the passenger transportation device PB.

For such transport of the information data ID a broadband signal with a noise-like character is ideally used as the masking signal. This ensures that on the one hand the masking signal fulfills a function as interference signal for a connection setup between mobile terminals ME with radio communication systems outside the passenger transportation device and on the other hand a high data rate for the transport of a useful signal—i.e. the informational data ID—will be provided. What is referred to as channel coding is used as suitable coding of the masking signal for example.

What is referred to as Spread-Spectrum Modulation or frequency spreading or what is referred to as the Orthogonal Frequency Division Multiplexing (OFDM) or the orthogonal frequency multiplexing method can be used for modulation of the masking signal. With these types of modulation for example high data rates for transmission of informational data ID can be provided very easily and at the same time interference such as e.g. signals from radio communication systems outside the passenger transportation device PB can be suppressed.

In a fourth method step 4 the informational data ID transported via the masking signal can then be forwarded by the antenna unit A to the output units AE1, . . . , AEn and can be output and displayed by said units accordingly in a fifth method step 5.

The output units AE1, . . . , AEn are equipped with corresponding receive units for this purpose, by which the sent informational data ID can be evaluated accordingly—i.e. prepared for an output for example by appropriate decoding and demodulation.

FIG. 2 shows a schematic diagram of an example of a variant of the inventive method for transmission of informational data ID in a passenger transportation device PB. In this exemplary variant, in addition to the output units AE1, AE2, . . . , mobile terminals ME located in the passenger transportation device PB, especially mobile telephones based on the Universal Mobile Telecommunication Systems (UMTS) standards, can also be used for output and display of the informational data ID. Since with UMTS for example Spread-Spectrum or frequency spreading technology is used as the modulation method, with suitable modulation of the masking signal, such as e.g. Spread-Spectrum modulation, a part of the spectrum of the masking signal can very easily be used for direct transmission of the informational data ID to a corresponding mobile terminal ME.

FIG. 2 therefore again shows the passenger transportation device PB with the informational system IS and the associated output units AE1, AE2, . . . , AEn. The passenger transportation device PB once again has a radio communication system BS, C, A, which is located inside the passenger transportation device PB. A control unit KE for creating the masking signal is again also provided.

However for output of the informational data ID to mobile terminals ME located in the passenger transportation device PB, in a method step 1a, parallel to the first method step 1, at least a part of the informational data ID is conveyed directly to the base station BS of the internal radio communication system BS, C, A, so that in further method step 2, 3 at least a part of the spectrum of the masking signal can be used for transport of the informational data stream ID directly to the mobile terminals ME, especially UMTS terminals, via the internal radio communication system BS, C, A. The data stream is again propagated via the antenna unit A and in a method step 4a, parallel to the fourth method step 4, reaches the mobile terminal ME.

In a method step 5a corresponding to the fifth method step 5, the informational data stream ID is then output and displayed on the mobile terminal ME. Thus, in a simple manner, available resources such as the radio communication BS, C, A located in the passenger transportation device can be used for the transmission of the informational data ID. If necessary, when the mobile terminals ME are used for data output and display, use of separate output units AE1, . . . , AEn can be dispensed with.

1-7. (canceled)

8. A method for transferring informational data in a passenger transportation device, the transportation device having an informational system with associated output units, wherein a setup of a connection between a plurality of mobile terminals located in the passenger transportation device and a radio communication system outside the passenger transportation device is suppressed by a masking signal of a control unit and/or the setup of a connection between the plurality of mobile terminals located in the passenger transportation device is diverted to the radio communication system located in the passenger transportation device, comprising:
creating a masking signal and then coding and modulating accordingly by the control unit; and
transferring the informational data with an aid of the masking signal from the informational system to the output units associated with the informational system for outputting the informational data.

9. The method as claimed in claim 8, wherein the informational data is transferred via an interface from the informational system to the control unit, and the masking signal is generated by the control unit and is used for transporting the informational data to the output units asspciated with the informational system.

10. The method as claimed in claim 8, wherein the output units associated with the informational system are equipped with a plurality of corresponding receive units for receiving and displaying the informational data, by which the informational data is received and evaluated.

11. The method as claimed in claim 8, wherein a broadband signal with a noise-like character is used as the masking signal, from which an interference signal is fulfilled by appropriate coding and modulation, and a high data rate is made available for the transportation of the informational data.

12. The method as claimed in claim 8, wherein Spread-Spectrum Modulation or Orthogonal Frequency Division Multiplexing are used for coding and/or modulation of the masking signal.

13. The method as claimed in claim 8, wherein fixed and/or mobile output devices are used as output units associated with the informational system.

14. The method as claimed in claim 8, wherein a part of a spectrum of the masking signal is used for transferring informational data of the informational system to the plurality of mobile terminals located in the passenger transportation device.

15. A device for transferring informational data in a passenger transportation device, the transportation device having an informational system with associated output units, wherein a setup of a connection between a plurality of mobile terminals located in the passenger transportation device and a radio communication system outside the passenger transportation device is suppressed by a masking signal of a control unit and/or the setup of a connection between the plurality of mobile terminals located in the passenger transportation device is diverted to the radio communication system located in the passenger transportation device, comprising:
means for creating a masking signal and then coding and modulating accordingly by the control unit; and
means for transferring the informational data with an aid of the masking signal from the informational system to the output units associated with the informational system for outputting the informational data.
